(19) United States
(12) Patent Application Publication
(10) Pub. No.: US 2024/0347244 A1
(43) Pub. Date: Oct. 17, 2024

(54) COATED SOFT MAGNETIC MATERIAL AND METHOD OF PRODUCING COATED SOFT MAGNETIC MATERIAL

(71) Applicant: NICHIA CORPORATION, Anan-shi (JP)

(72) Inventors: Ryoya OKAZAKI, Anan-shi (JP); Jun NISHITSUJI, Anan-shi (JP); Satoshi ABE, Tokushima-shi (JP); Jun AKAMATSU, Tokushima-shi (JP); Nobuyoshi IMAOKA, Anan-shi (JP)

(73) Assignee: NICHIA CORPORATION, Anan-shi (JP)

(21) Appl. No.: 18/634,412

(22) Filed: Apr. 12, 2024

(30) Foreign Application Priority Data
Apr. 14, 2023 (JP) 2023-066603

(51) Int. Cl. H01F 1/153

(52) U.S. Cl. CPC H01F 1/15383; H01F 1/15308

(57) ABSTRACT

A method of producing a coated soft magnetic material, including: a coating procedure including mixing an aqueous solution containing a phosphate compound and a metal oxoacid compound with a soft magnetic material to form a coating containing a metal phosphorus compound on a surface of the soft magnetic material.

### CROSS-REFERENCE TO RELATED PATENT APPLICATION

This application claims priority to Japanese Patent Application No. 2023-066603 filed on Apr. 14, 2023. The disclosure of Japanese Patent Application No. 2023-066603 is hereby incorporated by reference in its entirety.

### BACKGROUND

The present disclosure relates to a coated soft magnetic material and a method of producing such a coated soft magnetic material.

Powder magnetic cores molded from soft magnetic powders are used as magnetic core materials for motors, transformers, and other electrical equipment. When a soft magnetic powder is molded as it is, eddy currents can be generated throughout the resulting component due to conduction between the powder particles, resulting in higher iron loss. Japanese Patent publication No. 2011-127201 discloses a method of forming a coating containing hydroxyapatite on the surface of a soft magnetic powder in order to reduce iron loss in the resulting powder magnetic core. Japanese Patent publication No. H06-132109 discloses a method of forming a glassy insulating layer containing Cr or P as an essential element on the surface of a soft magnetic powder.

### SUMMARY

Embodiments of the present disclosure aim to provide a coated soft magnetic material having a coating with good heat resistance and a method of producing the same.

Exemplary embodiments of the present disclosure relate to a method of producing a coated soft magnetic material, including a coating procedure including mixing an aqueous solution containing a phosphate compound and a metal oxoacid compound with a soft magnetic material to form a coating containing a metal phosphorus compound on a surface of the soft magnetic material.

Exemplary embodiments of the present disclosure relate to a coated soft magnetic material, including: a soft magnetic material; and a coating on a surface of the soft magnetic material, wherein the coating includes an M component main phase mainly containing an M component, and an M compositional gradient phase positioned between the M component main phase and the soft magnetic material and has an M component content decreasing in a direction toward the soft magnetic material, the M compositional gradient phase has a thickness of at least 20 nm in a direction from the M component main phase toward the soft magnetic material, and the M component is at least one of Cr, W, Mn, Mo, Nb, or V.

The embodiments of the present disclosure can provide a coated soft magnetic material having a coating with good heat resistance and a method of producing the same.

### BRIEF DESCRIPTION OF DRAWINGS

FIG. 1A shows the line scan results of a coated soft magnetic material provided in Example 15.

FIG. 1B shows a scanning transmission electron microscope (STEM) image of the coated soft magnetic material provided in Example 15.

FIG. 2 includes a STEM image and EDX (energy dispersive X-ray analysis) mapping images of a cross-section of a molded product of a coated soft magnetic material provided in Example 7.

FIG. 3 shows line scan results of the coated soft magnetic material provided in Example 7.

FIG. 4 shows line scan results of the coated soft magnetic material provided in Example 7.

FIG. 5A is a Mn distribution chart measured by STEM-EDX analysis of a coated soft magnetic material provided in Example 16.

FIG. 5B is a histogram showing the distribution of Mn content in the coated soft magnetic material provided in Example 16.

### DETAILED DESCRIPTION

Embodiments of the present disclosure are described in detail below. The following embodiments, however, are intended as examples to embody the technical idea of the present disclosure and are not intended to limit the scope of the present disclosure to the following embodiments. As used herein, the term “procedure” encompasses not only an independent procedure but also a procedure that may not be clearly distinguished from other procedures, as long as a desired object of the procedure is achieved. Moreover, numerical ranges indicated using “to” refer to ranges including the numerical values before and after “to” as the minimum and maximum, respectively.

### Method of Producing Coated Soft Magnetic Material

A method of producing a coated soft magnetic material according to the present embodiments includes a coating procedure including mixing an aqueous solution containing a phosphate compound and a metal oxoacid compound with a soft magnetic material to form a coating containing a metal phosphorus compound on a surface of the soft magnetic material. Here, the metal component (e.g., iron) contained in the soft magnetic material is reacted with the phosphate component contained in the phosphate compound, so that a phosphorus compound (e.g., iron phosphate) is precipitated on the surface of the soft magnetic material to form a coating. Further, because the metal oxoacid compound is also present in the aqueous solution, the metallic element derived from the metal oxoacid compound is bound to the surface of the soft magnetic material, so that a compound of the metallic element and phosphorus is precipitated. The metal phosphorus compound may be a metal phosphate. The coating containing the metal phosphorus compound may be a coating containing a metal phosphate.

### Soft Magnetic Material

In the present embodiments, the magnetic material used is a soft magnetic material. The soft magnetic material is a material with low coercivity and high saturation flux density. Examples of the soft magnetic material include oxide-based soft magnetic materials and metal-based soft magnetic materials. The soft magnetic material can be a material with a coercivity of not more than 10 Oe (795.8 A/m) and a saturation flux density of at least 0.3 T. The soft magnetic material can be a material with a coercivity of not more than 5 Oe (397.9 A/m) and a saturation flux density of at least 1.0 T.

Examples of the oxide-based soft magnetic materials include materials containing an iron oxide and a transition metal such as Ni, Zn, Cu, Mn, or Co. Specific examples include Mn—Zn-based soft ferrites, Ni—Zn-based soft ferrites, and Cu—Zn-based soft ferrites. Examples of the metal-based soft magnetic materials include pure irons, Fe—X alloys (X: Ti, Mn, Ni, Co, Zr, Hf, V, Nb, Ta, Cr, Mo, W, Cu, Zn, Si), silicon steels (Fe—Si), Sendusts (Fe—Si—Al), Permendurs (Fe—Co), permalloys (Fe—Ni), electromagnetic stainless steels (Fe—Cr), and rapidly quenched ribbon powders (Fe—Si—B, Fe—Si—B—P—Cu). Examples of the pure irons include atomized iron, reduced iron, electrolytic iron, and carbonyl iron.

An Fe—X alloy contains a first phase containing Fe and X and a second phase containing X and having an X content that, when the sum of Fe and X in the second phase is taken as 100 atom %, is higher than the X content of the first phase when the sum of Fe and X in the first phase is taken as 100 atom %. The use of an Fe—X alloy as a soft magnetic material can further improve heat resistance. X is at least one selected from Ti, Mn, Ni, Co, Zr, Hf, V, Nb, Ta, Cr, Mo, W, Cu, Zn, and Si, and at least two of these may be selected. The first phase of the Fe—X alloy may have crystals with a bcc structure containing Fe and X. Preferably, except when X includes Co, both the first and second phases of the Fe—X alloy have crystals with a bcc structure containing Fe and X. This can improve magnetization. The crystallite size of the bcc phase in the first and/or second phase of the Fe—X alloy is preferably at least 1 nm but less than 100 nm. X can include Ni and/or Co and other additional components. In this case, the additional component content in the second phase is preferably higher than the additional component content in the first phase. The additional component contents in the first and second phases each refer to the additional component content (atom %) when the sum of X components including additional components and Fe in the corresponding first or second phase is taken as 100 atom %. This allows both low coercivity and improved magnetization to be achieved.

When the first and second phases have crystals with a bcc structure containing Fe and X components, the ratio of the X component content in the second phase to the X component content in the first phase, the second phase/first phase X component ratio, can be at least 1, and may be at least 1.1 but not more than 105. The X component contents in the first and second phases each refer to the X component content (atom %) when the sum of Fe and X in the corresponding first or second phase is taken as 100 atom %. Such a second phase/first phase X component ratio allows both low coercivity and high magnetization to be achieved, and is thus suitable for a soft magnetic material with good high-frequency characteristics.

When the X components include Ti or Mn, the ratio of the Ti or Mn content in the second phase to the Ti or Mn content in the first phase, the second phase/first phase component ratio for Ti or Mn, is preferably at least 2 but not more than 105. When the X components include one of Zr, Hf, V, Nb, Ta, Cr, Mo, W, Cu, Zn, and Si, the second phase/first phase component ratio for the corresponding component is preferably at least 1.5 but not more than 105. When the X components include Ni or Co, the second phase/first phase component ratio for the corresponding component is preferably more than 1, more preferably at least 1.1 but not more than 105. These second phase/first phase X component ratios make it possible to achieve both low coercivity and high magnetization and, for example, to obtain a soft magnetic material with a coercivity of not more than 10 Oe and a magnetization of at least 0.3 T. Such a soft magnetic material can be used to achieve lower losses in high-frequency applications. The Fe—X alloy can have a structure in which the nanoscale first and second phases are connected by ferromagnetic bonds due to the presence of nano-order X compositional fluctuations caused by disproportionation reactions during reduction. Such a structure probably leads to low coercivity and high magnetization. The Fe—X alloy can be obtained, for example, as described in WO 2017/164376 or WO 2018/155608.

The soft magnetic materials listed above may be used alone or in combinations of two or more. Among the soft magnetic materials, metal-based soft magnetic materials are preferred. This is because, when a metal-based soft magnetic material is used and coated as described later, it is easier to increase the electrical resistance of the magnetic material molded product and reduce losses, thus improving magnetization. Among the metal-based soft magnetic materials, pure irons or Fe—X alloys are preferred. In particular, Fe—X alloys with X being Mn (such alloys are referred to as “Fe—X (X=Mn”)), Fe—X alloys with X being Ni (such alloys are referred to as “Fe—X (X=Ni)”), or Fe—X alloys with X being Mn and Ni (such alloys are referred to as “Fe—X (X=Mn, Ni)”) are more preferred. These components listed as X may be X main components. When X=Mn, Ni, other components may be included in an amount smaller than the amount of Mn, Ni. More preferably, X consists substantially only of Mn and Ni. Fe—X (X=Mn) tends to have higher electrical resistance and heat resistance than Fe powder (pure iron) does. This is probably due to the inclusion of an X component-enriched phase. Fe—X (X=Ni) shows higher magnetization when the Ni content is higher than 0 but not higher than 12 atom %, as expected from the Slater-Pauling curve. Fe—X (X=Mn, Ni) can have the advantages of both Fe—X (X=Mn) and Fe—X (X=Ni). In other words, it is possible to increase electrical resistance and therefore reduce eddy current loss, and improve heat resistance and magnetization.

The soft magnetic material used is preferably in a powder form to facilitate the formation of a powder magnetic core of any shape. The particle size D50 of the magnetic powder can be, for example, at least 1 μm but not more than 5 mm, preferably at least 5 μm but not more than 1 mm, more preferably at least 10 μm but not more than 500 μm. In this range, coercivity can be reduced, and distortions during annealing can be reduced. Herein, the particle size D50 refers to the particle size corresponding to 50% of the cumulative particle size distribution by volume of the magnetic powder.

The coating procedure is preferably preceded by washing the soft magnetic material with an acidic aqueous solution to remove the impurities and oxide layer on the surface of the soft magnetic material. The acid compound used in the washing may be an inorganic or organic acid. Examples of the inorganic acid include sulfuric acid, hydrochloric acid, nitric acid, phosphoric acid, boric acid, and hydrofluoric acid. Examples of the organic acid include acetic acid, formic acid, oxalic acid, and tartaric acid. The pH during the washing is preferably less than pH 7, more preferably less than pH 3. The washing time is preferably at least one minute but not more than 10 hours. During the washing, the aqueous solution is preferably stirred.

### Coating Procedure

In the coating procedure, an aqueous solution containing a phosphate compound and a metal oxoacid compound is mixed with a soft magnetic material. As a result, the metal component in the soft magnetic material is reacted with the phosphate component in the phosphate compound to form a coating containing a phosphorus compound on the surface of the soft magnetic material. Further, the metal contained in the metal oxoacid compound is bound to the surface of the soft magnetic material, so that a compound of the metal and phosphate is precipitated. The coating obtained in the coating procedure may be a coating containing a metal phosphorus compound or a coating containing a metal phosphate. Depending on the combination of elements in the coating and the atmosphere during heating after the coating formation, a coating containing a phosphorus compound other than phosphates may be obtained through heating after a coating containing a metal phosphate is formed.

In the coating procedure, the amount of the soft magnetic material in the mixture of the aqueous solution containing a phosphate compound and a metal oxoacid compound with the soft magnetic material is preferably at least 0.0001% by mass but not higher than 70% by mass, more preferably at least 0.01% by mass but not higher than 10% by mass. In such a range, the thickness of the coating tends to increase, and the heat resistance tends to improve.

Examples of the phosphate compound contained in the aqueous solution include orthophosphoric acid, sodium dihydrogen phosphate, sodium monohydrogen phosphate, ammonium dihydrogen phosphate, ammonium monohydrogen phosphate, zinc phosphate, calcium phosphate, and other phosphates, hypophosphorous acid and hypophosphites, pyrophosphoric acid, polyphosphoric acid, and other inorganic phosphoric acids, and organic phosphoric acids, and salts thereof. These may be used alone or in combinations of two or more.

The amount of the phosphate compound, calculated as PO₄, in the aqueous solution is preferably at least 0.0001% by mass but not more than 50% by mass, more preferably at least 0.001% by mass but not more than 10% by mass. In such a range, the phosphate compound tends to have high solubility in water and high storage stability.

The metal oxoacid compound contained in the aqueous solution is an acid compound containing metal and oxygen atoms. When the coating procedure is performed in the aqueous solution containing the metal oxoacid compound, the amount of the coating adhering to the surface of the soft magnetic material can be increased and the heat resistance can be improved. The metal oxoacid compound is preferably an oxoacid compound of a metallic element M, i.e., Cr, W, Mn, Mo, Nb, or V, such as a compound containing chromate (e.g., CrO₄²⁻), tungstate (e.g., WO₄²⁻), manganate (e.g., MnO₄²⁻), molybdate (MoO₄²⁻), niobate (NbO₃⁻), vanadate (VO₄³⁻), or polyoxoacid thereof (any of the foregoing is referred to as a M oxyacid). These oxoacid compounds may be any compounds that can form an oxoacid in the aqueous solution, and may be, for example, a salt of an oxoacid compound with an alkali metal element such as Na, K, or Li, an alkaline earth metal element such as Ca or Ba, phosphoric acid, or silicic acid. These metal oxoacid compounds are also referred to as M oxoacid compounds. The M component in the oxoacid compound, together with the iron component in the magnetic powder once dissolved by the acid component in the aqueous solution, may act on the surface to form a passive film. For example, M may stabilize the inner layer of the passive film or create a less defective coating, or the M oxyacid may be adsorbed onto the defective parts of the coating to improve the coverage, thereby imparting good oxidation resistance and good heat resistance. For example, the coating includes a continuous phase with an M compositional gradient from an iron oxide main phase located on the surface of the soft magnetic material such as iron-based magnetic powder to a phosphate compound main phase (M component main phase) in which the compositional percentage of M becomes somewhat constant. Such a continuous phase can function as a base for the phosphate compound main phase of the coating where the phosphate compound is the main component. Here, the phrase “the compositional percentage of M becomes somewhat constant” means that the M component content falls within a range of 50 atom % to 150 atom % of the median M content in the phosphate compound main phase. The phosphate compound main phase may have a somewhat constant compositional percentage of Fe, while the continuous phase may have a compositional gradient of Fe.

The presence of such a continuous phase with a compositional gradient, i.e., compositional gradient phase, inhibits cracking or separation between the coating and the soft magnetic material due to thermal stress or mechanical stress. This, in turn, can reduce the degradation of the soft magnetic material caused by heating to a straightening temperature or other temperature. The M compositional gradient phase is probably generated by the action of the M oxyacid. An M component or Ni, for example, is preferably contained also in the soft magnetic material because the coating can be further stabilized. Suitable examples of the soft magnetic material include Fe—X (X=Mn), Fe—X (X=Ni), Fe—X (X=Mn, Ni), Fe—X (X=M), Fe—X alloys, and Fe—Si.

The amount of the metal oxoacid compound in the aqueous solution is preferably at least 0.001% by mass but not more than 10% by mass, more preferably at least 0.01% by mass but not more than 5% by mass. In such a range, the metal oxoacid compound tends to have high solubility in water and high storage stability.

The aqueous solution used in the coating procedure may further contain a compound of a metallic element or a semimetallic element other than the metal oxoacid compounds described above.

Examples of the metallic element include transition metal elements such as Ti, Zr, Hf, V, Nb, Ta, Cr, Mo, W, Mn, Fe, Ru, Co, Ni, Pd, Pt, Cu, Ag, and Au; rare earth metal elements such as Ce, Sm, La, Dy, Nd, Y, and Pr; alkali metal elements such as Li, Na, K, Rb, and Cs; alkaline earth metal elements such as Ca, Sr, and Ba; and typical metallic elements except semimetallic elements, such as Zn, Cd, and Al. Examples of the semimetallic element include B, Si, and Ge. Among these, metallic elements are preferred.

In order to obtain a coated soft magnetic material with good heat resistance, the metallic element preferably has a small Gibbs energy change (AG) for the oxidation reaction in the temperature range (e.g., at least 400° C. but not higher than 700° C.) when the coated soft magnetic material is heated. The metallic element is preferably an element having a Gibbs energy change (ΔG) of −300 KJ/mol O₂ or less. The metallic element is preferably a rare earth metal element, more preferably Sm, Nd, La, or Dy. The Gibbs free energy changes for the oxidation reactions at 600° C. of metallic element oxides are shown in Table 1.

TABLE 1

| Element | Δ G for oxidation at 600° C. [kJ/mol O₂] |
|---|---|
| Ca | −1086.9 |
| Cu | −212.4 |
| Ni | −320.2 |
| W | −416.2 |
| Fe | −420.2 |
| Mo | −432.9 |
| K | −482.7 |
| Zn | −523.6 |
| Na | −596.4 |
| Cr | −599.1 |
| Mn | −641.8 |
| Ta | −666.0 |
| Nb | −675.2 |
| V | −709.6 |
| Si | −752.5 |
| Ti | −900.0 |
| Ce | −907.9 |
| Hf | −910.8 |
| Zr | −931.7 |
| Ba | −933.4 |
| Al | −934.8 |
| Mg | −1014.9 |
| La | −1028.5 |
| Nd | −1039.9 |
| Sm | −1046.5 |
| Dy | −1069.1 |

The compound of the metallic element or semimetallic element added to the aqueous solution is a different compound from the phosphate compound added to the aqueous solution. Examples of the compound of the metallic element or semimetallic element include oxides, chlorides, hydroxides, sulfates, nitrates, and acetates of metallic elements or semimetallic elements. Chlorides are preferred because they can easily generate ions in the aqueous solution and can also easily form a composite compound with the Fe ions present in the aqueous solution. The compounds of metallic elements or semimetallic elements listed above may be used alone or in combinations of two or more, in addition to the metal oxoacid compound.

The amount of the compound of the metallic element or semimetallic element in the aqueous solution is preferably at least 0.001% by mass but not more than 10% by mass, more preferably at least 0.01% by mass but not more than 5% by mass. In such a range, the compound tends to have high solubility in water and high storage stability.

To improve the water resistance and corrosion resistance of the coating and the magnetic properties of the magnetic powder, additives may also be added including, for example, oxidizing agents such as sodium nitrate and sodium nitrite; and chelating agents such as EDTA. When the aqueous solution contains an oxidizing agent, the concentration thereof in the aqueous solution is preferably at least 0.0001% by mass but not higher than 10% by mass, more preferably at least 0.01% by mass but not higher than 1% by mass. When the aqueous solution contains a chelating agent, the concentration thereof in the aqueous solution is preferably at least 0.0001% by mass but not higher than 10% by mass, more preferably at least 0.01% by mass but not higher than 1% by mass.

Examples of the reaction solvent used in the coating procedure include water and solvent mixtures of water and hydrophilic organic solvents. When these solvents are used, a smaller particle size phosphate compound may precipitate to form a denser coating than when hydrophobic organic solvents are used. Water is preferred among the solvents above. When a solvent mixture of water and a hydrophilic organic solvent is used, examples of the hydrophilic organic solvent include ethanol, methanol, 2-propanol, acetone, and 2-butanone. The amount of the hydrophilic organic solvent in the solvent mixture is preferably at least 0.1% by mass but not more than 80% by mass, more preferably at least 1% by mass but not more than 50% by mass.

The reaction time taken to form a coating on the surface of the magnetic material is preferably at least one minute but not more than 10 hours, more preferably at least five minutes but not more than two hours.

In the coating procedure, as long as an aqueous solution containing a phosphate compound and a metal oxoacid compound can be ultimately mixed with a soft magnetic material, the components may be mixed in any order. In the coating procedure, preferably, an aqueous solution containing the metal oxoacid compound is firstly mixed with the soft magnetic material and then with the phosphate compound or an aqueous solution containing the phosphate compound. Mixing an aqueous solution containing the metal oxoacid compound with the soft magnetic material in advance allows the metallic element derived from the metal oxoacid compound to easily bind to the surface of the soft magnetic material, making it possible to increase the amount of the coating. When the aqueous solution containing the metal oxoacid compound is mixed with the soft magnetic material in advance, the mixture obtained by mixing them may be stirred preferably for at least five minutes, more preferably at least 10 minutes, before adding the phosphate compound or an aqueous solution containing the phosphate compound.

In the coating procedure, the pH of the aqueous solution may increase as the phosphate derived from the phosphate compound adheres to the soft magnetic material. In this case, the pH of the aqueous solution may be adjusted by adding an inorganic acid or an organic acid. The pH may be adjusted within a range of higher than 0 but lower than 7, preferably at least 1 but not higher than 4.5, more preferably at least 1.6 but not higher than 3.9, still more preferably at least 2 but not higher than 3. When the pH is at least 1, the precipitation rate of the phosphate compound can be reduced compared to when the pH is lower than 1, and the thickness of the coating to be formed can be easily controlled. When the pH is at least 7, the amount of the precipitated phosphate compound tends to decrease, resulting in insufficient coating and increased losses. Thus, the pH is preferably lower than 7. When the pH is not higher than 4.5, the precipitation rate of the phosphate compound can be not too low. The acid to be added may be an inorganic acid or an organic acid. Examples of the inorganic acid include sulfuric acid, hydrochloric acid, nitric acid, phosphoric acid, boric acid, and hydrofluoric acid. Examples of the organic acid include acetic acid, formic acid, oxalic acid, and tartaric acid. Although an inorganic acid is preferably used in view of liquid waste disposal, an organic acid may be used together depending on the purpose. An inorganic acid and an organic acid may be used in admixture. When the pH is adjusted, the inorganic or organic acid may be added as needed to adjust the pH within the above-mentioned range during the coating procedure. In the initial stage of the coating procedure, where the pH increases rapidly, the inorganic or organic acid for pH control is preferably introduced at short intervals.

The inorganic acid or organic acid may be added to the aqueous solution to adjust the pH within the range of at least 1 but not higher than 4.5 for at least one minute, preferably for at least 10 minutes. To reduce the thin parts of the coating, this pH adjustment is more preferably performed for at least 30 minutes. In the initial stage of pH maintenance, where the pH increases rapidly, the inorganic or organic acid for pH control is preferably introduced at short intervals. Then, as the coating proceeds, pH fluctuations gradually decrease, which permits the inorganic or organic acid to be introduced at longer intervals. This allows one to determine the end point of the reaction.

After the coating procedure, the soft magnetic material on which the coating is formed may be purified. The magnetic material on which the coating is formed can be purified, for example, by heating at at least 100° C. but not higher than 500° C. or by filtration with a filter.

In the method of producing a coated soft magnetic material according to the present embodiments, although the coating procedure may be performed only once, it may be performed at least twice. By performing the coating procedure at least twice, a thick coating containing a metal phosphorus compound can be formed on the surface of the soft magnetic material. Although the upper limit of the number of times the coating procedure is performed is not limited, it can be, for example, not more than 10.

When the coating procedure is performed at least twice, the soft magnetic material may be purified between the coating procedure and the next coating procedure. The magnetic material on which the coating is formed can be purified, for example, by heating at at least 100° C. but not higher than 500° C. or by filtration with a filter.

When the coating procedure is performed at least twice, the aqueous solution used in the k-th coating procedure is preferably obtained by adding the metal oxoacid compound to the aqueous solution used in the (k−1)th coating procedure. In this case, the k-th coating procedure can be performed without purifying the soft magnetic material after the (k−1)th coating procedure. Here, k is an integer of at least 2, but when the coating procedure is performed n times, k is preferably any integer of at least 2 but not more than n. When k is any integer of at least 2 but not more than n, an aqueous solution obtained by adding the metal oxoacid compound to the aqueous solution used in the coating procedure is used in each of the second and subsequent coating procedures.

The concentration of the metal oxoacid compound added to the aqueous solution used in the (k−1)th coating procedure may be selected appropriately according to the reaction time of the k-th coating procedure and the type of metal oxoacid compound. The concentration of the metal oxoacid compound added to the aqueous solution used in the (k−1)th coating procedure is preferably at least 0.01 times but not more than 50 times, more preferably at least 0.1 times but not more than 10 times, the metal oxoacid compound content in the aqueous solution used in the k-th coating procedure. In such a range, the thickness unevenness of the coating can be reduced.

When the coating procedure is performed at least twice, the metal oxoacid compound used in the m-th coating procedure may be different from the metal oxoacid compound used in the (m−1)th coating procedure. Here, m is an integer of at least 2. When the metal oxoacid compound used in the m-th coating procedure is different from the metal oxoacid compound used in the (m−1)th coating procedure, the metallic element derived from the metal oxoacid compound used in the (m−1)th coating procedure and the metallic element derived from the metal oxoacid compound used in the m-th coating procedure tend to accumulate in this order in the coating in the direction from the base material soft magnetic material to the surface of the finally formed coating.

When the coating procedure is performed at least twice, the pH of the mixture of the aqueous solution and the soft magnetic material obtained in the p-th coating procedure is preferably lower than the pH of the mixture of the aqueous solution and the soft magnetic material obtained in the (p−1)th coating procedure, and the difference therebetween is preferably at least 0.1, more preferably at least 1. Here, as the reaction between the phosphate compound and the soft magnetic material proceeds, the free phosphate content in the aqueous solution may decrease, and the pH of the mixture of the aqueous solution and the soft magnetic material may increase. If the pH fluctuates during the reaction, the pH of the mixture of the aqueous solution and the soft magnetic material obtained in the (p−1)th coating procedure refers to the pH at the end of the (p−1)th coating procedure. When the pH of the mixture of the aqueous solution and the soft magnetic material obtained in the p-th coating procedure is lower than that in the (p−1)th procedure, the efficiency of forming a coating containing a metal phosphorus compound on the soft magnetic material can be improved.

Here, p is an integer of at least 2, but when the coating procedure is performed n times, p is preferably any integer of at least 2 but not more than n. When p is any integer of at least 2 but not more than n, an aqueous solution with a pH lower than the pH of the mixture of the aqueous solution and the soft magnetic material obtained in the previous coating procedure is used in each of the second and subsequent coating procedures.

In the p-th coating procedure, an inorganic acid or an organic acid is preferably added to the aqueous solution to adjust the pH to at least 0 but lower than 7. The pH range is more preferably at least 1.6 but not higher than 3.9, still more preferably at least 2 but not higher than 3. If the pH is lower than 0, the precipitation rate of the phosphorus compound tends to be too high, making it difficult to control the film thickness. If the pH is at least 7, the amount of the precipitated phosphorus compound tends to decrease, resulting in insufficient coating and increased iron loss. If the pH is higher than 7, the precipitation rate of the phosphorus compound tends to be low. Examples of the acid added include inorganic acids such as sulfuric acid, hydrochloric acid, nitric acid, phosphoric acid, boric acid, and hydrofluoric acid; and organic acids such as acetic acid, formic acid, oxalic acid, and tartaric acid. Although an inorganic acid is preferably used in view of liquid waste disposal, an organic acid may be used together depending on the purpose. An inorganic acid and an organic acid may be used in admixture. The pH can be adjusted within the range of at least 0 but lower than 7 for at least one minute. To reduce the thin parts of the coating, this pH adjustment is preferably performed for at least 30 minutes.

The coating procedure may be followed by purifying the coated soft magnetic material. In the coated soft magnetic material purification procedure, the liquid component can be removed, for example, by heating at at least 100° C. but not higher than 500° C. or by filtration with a filter.

The coating procedure may also be followed by fixing the coating. In the coating fixation procedure, the purified coated soft magnetic material may be treated at a high temperature so that the phosphorus is baked onto the magnetic material. The temperature conditions of the high temperature treatment are preferably at least 50° C. but not higher than 500° C., more preferably at least 100° C. but not higher than 300° C. The high temperature treatment time is preferably at least one minute but not more than 100 hours, more preferably at least 10 minutes but not more than 10 hours.

### Method of Producing Molded Product

A method of producing a molded product according to the present embodiments includes obtaining a coated soft magnetic material and heating the coated soft magnetic material. The procedure of obtaining a coated soft magnetic material can be performed as described above for the method of producing a coated soft magnetic material.

In the heating procedure, the coated soft magnetic material is heated. The heating temperature is, for example, at least 100° C. but not higher than 1200° C. The heating procedure can be performed, for example, in order to release stress caused by pressurization and/or to partially react the coating of the coated soft magnetic material to obtain an integrated molded product. To release stress caused by pressurization, the heating temperature is preferably at least 300° C. but not higher than 1000° C., more preferably at least 400° C. but not higher than 700° C. As the coated soft magnetic material used in the present embodiments has a coating with good heat resistance, the losses of the coating can be reduced even after the heating procedure. The heating temperature may be at least 500° C. In this case, the molded product preferably does not contain resin or glass. This is because resin and glass are likely to degrade significantly at high temperatures of at least 500° C. The duration of the heating procedure is preferably at least one minute but not more than 100 hours, more preferably at least 10 minutes but not more than 10 hours. The heating procedure may be carried out in a nitrogen atmosphere or in the air, for example. The heating procedure is preferably carried out in an inert atmosphere such as an argon atmosphere or vacuum. This can inhibit the progression of oxidation of the coated soft magnetic material and reduce the deterioration of the characteristics.

The heating procedure is preferably preceded by pressurizing the coated soft magnetic material to obtain a pressure molded product. In this case, the heating procedure corresponds to heating the pressure molded product obtained in the procedure of obtaining a pressure molded product.

The pressurization conditions are preferably at least 0.01 GPa but not higher than 10 GPa, more preferably at least 0.5 GPa but not higher than 5 GPa. The coated magnetic material may be disposed into a mold and then pressurized to obtain a pressure molded product of the desired shape. When a mold is used, a lubricant, which will be described later, may be applied to the inner walls of the mold cavity before disposing the coated magnetic material. Applying a lubricant to the inner walls of the mold cavity can improve the releasability of the pressure molded product from the mold.

In the pressurization, the coated soft magnetic material may be pressurized alone. In the pressurization, the coated soft magnetic material may be mixed with a binder, a lubricant, etc. before being pressurized. Examples of the binder include thermosetting resins such as epoxy resins, urethane resins, phenol resins, methacrylic resins, acrylic resins, and silicone resins, and thermoplastic resins such as polyamide resins. The amount of the binder used per 100 parts by mass of the coated soft magnetic material is preferably at least 0.01 parts by mass but not more than 1000 parts by mass, more preferably at least one part by mass but not more than 50 parts by mass. When the amount of the binder used is within the above range, a molded product with good mechanical strength such as shock resistance and low eddy current loss of iron loss can be obtained. Whether or not to use a resin, and if so, the type of resin used, can be determined according to the application.

Examples of the lubricant include metallic soaps such as zinc stearate, calcium stearate, and lithium stearate, amines or amides such as 1,2-bis(stearoylamino) ethane, long chain hydrocarbons such as waxes, and silicone oils. The amount of the lubricant used per 100 parts by mass of the coated soft magnetic material is preferably at least 0.00001 parts by mass but not more than 10 parts by mass, more preferably at least 0.01 parts by mass but not more than five parts by mass. When the amount of the lubricant used is within the above range, the releasability of the pressure molded product from the mold cavity can be improved.

The filling ratio of the molded product obtained in the present embodiments can be at least 10% but not higher than 100%, preferably at least 80% but not higher than 100%. The filling ratio here refers to the ratio (percentage) of the molded product density to the true density. The ratio (percentage) of the volume of the coated soft magnetic material to the volume of the molded product obtained in the present embodiments may be at least 40% but not higher than 100%, preferably at least 80% but not higher than 100%. The ratio of the area of the coated soft magnetic material to the area of the molded product in a cross-section of a portion of the molded product may be regarded as the ratio of the volume of the coated soft magnetic material to the volume of the molded product.

Because the molded product obtained in the present embodiments is an aggregate of the coated soft magnetic material having a coating with good heat resistance, the coating is maintained after the heating procedure, and losses such as iron loss can be reduced. After the heating procedure, the coatings of the individual coated soft magnetic material particles may partially react to fuse and integrate with the coatings of the adjacent coated soft magnetic material particles while maintaining the insulation between the soft magnetic material particles. The soft magnetic material according to the present embodiments can be formed into a molded product without using a binder such as resin or glass. Resin can give rise to eddy currents when carbonized by heat treatment. Glass can also be degraded by heat treatment. For these reasons, when a binder such as resin or glass is used, the temperature of the heat treatment, if performed, is desirably relatively low. In the case of a molded product containing no resin or glass, even when heated at a relatively high temperature such as 500° C. or higher, it is possible to reduce the increase in losses. Moreover, heating at a relatively high temperature can more effectively release stress caused by pressurization. Moreover, the combined use with the lubricant described above can increase the molded product density and allow the adjacent coated magnetic material particles to be bonded through a chemical reaction, thereby improving mechanical strength.

### Coated Soft Magnetic Material

A coated soft magnetic material according to the present embodiments includes a soft magnetic material, and a coating containing a metal phosphorus compound provided on a surface of the soft magnetic material. The coated soft magnetic material according to the present embodiments can be produced by any method such as the method of producing a coated soft magnetic material described above. The material and particle size of the soft magnetic material are as described above for the method of producing a coated soft magnetic material.

The coating according to the present embodiments contains an M component. The M component is preferably Cr, W, Mn, Mo, Nb, or V. The coating can include a phase mainly containing an M component whose compositional percentage is somewhat constant (M component main phase) and an M compositional gradient phase that is positioned between the M component main phase and the soft magnetic material and has an M component content decreasing in the direction from the surface of the coating toward the soft magnetic material. This can provide good heat resistance to the resulting coated soft magnetic material. The minimum M component content in the M compositional gradient phase is preferably at least 0.2 times but not more than 0.8 times the M component content in the M component main phase. This can stabilize the production of the coating. The thickness of the M compositional gradient phase is preferably at least 1 nm but not more than 1 μm. This can make the film more resistant to cracking or separation due to stress. Such contents and thicknesses further improve the heat resistance of the coated soft magnetic material. The thickness of the M compositional gradient phase is more preferably at least 20 nm but not more than 200 nm.

The coating according to the present embodiments contains a metal phosphorus compound. Examples of the metal component constituting the metal phosphorus compound include transition metal elements such as Ti, Zr, Hf, V, Nb, Ta, Cr, Mo, W, Mn, Fe, Ru, Co, Ni, Pd, Pt, Cu, Ag, and Au; rare earth metal elements such as Ce, Sm, La, Dy, Nd, Y, and Pr; alkali metal elements such as Li, Na, K, Rb, and Cs; alkaline earth metal elements such as Ca, Sr, and Ba; and typical metallic elements except semimetallic elements, such as Zn, Cd, and Al. Examples of the semimetallic elements include B, Si, and Ge. Among these, metals having a small Gibbs energy change (AG) for the oxidation reaction at at least 400° C. but not higher than 700° C. are preferred in order to improve the heat resistance of the coating. Elements having a Gibbs energy change (AG) for the oxidation reaction at 600° C. that is-300 KJ/mol O₂ or less are preferred, with rare earth metal elements being more preferred, with Sm, Nd, La, and Dy being still more preferred. The metal phosphorus compound may contain only one type or two or more types of these metals. For example, the metal phosphorus compound preferably contains a rare earth metal element and a non-rare earth metal element. Examples of the non-rare earth metal element include the metals listed as the metal component constituting the metal phosphorus compound, excluding rare earth metal elements. Moreover, these metals may be those derived from the base material soft magnetic material or those contained in the aqueous solution used in the coating procedure in the production of the coated soft magnetic material.

The thickness of the coating containing the metal phosphorus compound is preferably at least 2 nm but not more than 10 μm, more preferably at least 5 nm but not more than 500 nm, in terms of the insulating properties and heat resistance of the coated soft magnetic material. The thickness of the coating can be measured by compositional analysis using an EDX line scan of a cross-section of the coated soft magnetic material.

The coating provided on the surface of the soft magnetic material preferably contains oxygen and phosphorus in addition to the metal phosphorus compound. Oxygen is preferably present in a larger amount than phosphorus. There should be some region where oxygen is present in a larger amount than phosphorus in the thickness direction of the coating. The region where oxygen is present in a larger amount than phosphorus preferably accounts for at least 10%, more preferably at least 50%, still more preferably the entire region, in the thickness direction of the coating. The amount of oxygen is preferably at least one times, more preferably at least three times the amount of phosphorus. The upper limit of the amount of oxygen can be, for example, not more than 10 times the amount of phosphorus.

In the direction from the surface of the coating toward the soft magnetic material, the amount of the M component as a non-rare earth metal element may show the maximum value, then decrease, and then begin to increase. When the coating is formed by performing the coating procedure at least twice, but the pH of the mixture of the aqueous solution and the soft magnetic material used in the p-th coating procedure, where p is an integer of at least 2, is lower than the pH of the mixture of the aqueous solution and the soft magnetic material used in the (p−1)th coating procedure, the amount of the non-rare earth metal element tends to have such a distribution, thereby improving the heat resistance of the coating. The minimum value of the amount of the non-rare earth metal element decreasing after showing the maximum value but before beginning to increase is preferably not more than 0.9 times, more preferably not more than 0.5 times, the maximum value. The lower limit of the minimum value is not limited and can be at least 0.001 times the maximum value.

In the coating, each of the above-mentioned metals may be present in either crystalline or amorphous form. The concentration (atom %) of each metal in the coating can be measured by compositional analysis using an EDX line scan of the coated soft magnetic material. The presence of a phosphate compound or composite oxide in microcrystalline form in the coating can increase mechanical strength and improve heat resistance.

The rare earth metal element content in the coated soft magnetic material is preferably at least 0.0001% by mass, more preferably at least 0.01% by mass, still more preferably at least 0.1% by mass. When the rare earth metal element content is at least 0.0001% by mass, the coated soft magnetic material tends to be resistant to heat treatment at high temperatures. When the rare earth metal element content is at least 0.01% by mass, the coated soft magnetic material tends to be resistant to heat treatment at higher temperatures. When the rare earth metal element content is at least 0.1% by mass, a coated soft magnetic material with further improved insulating properties tends to be obtained. The upper limit of the rare earth metal element content can be not more than 50% by mass, preferably not more than 10% by mass. If the rare earth metal element content in the coated soft magnetic material is more than 50% by mass, the coated soft magnetic material may have reduced magnetic permeability and deteriorated characteristics. The rare earth metal element content in the coated soft magnetic material can be measured by ICP atomic emission spectroscopy (ICP-AES).

The phosphorus content in the coated soft magnetic material is preferably at least 0.0001% by mass but not higher than 15% by mass, more preferably at least 0.001% by mass but not higher than 5% by mass. In the above range, the heat resistance tends to improve. The phosphorus content in the coated soft magnetic material can be measured by ICP atomic emission spectroscopy (ICP-AES).

The iron loss W of the coated soft magnetic material is preferably not more than 210 W/kg, more preferably not more than 100 W/kg, still more preferably not more than 80 W/kg. The lower limit of the iron loss W can be, for example, at least 4 W/kg. The hysteresis loss Wₕ of the coated soft magnetic material is preferably not more than 80 W/kg, more preferably not more than 60 W/kg, still more preferably not more than 50 W/kg. The lower limit of the hysteresis loss Wₕ can be at least 3.9 W/kg. The eddy current loss Wₑ of the coated soft magnetic material is preferably not more than 130 W/kg, more preferably not more than 40 W/kg, still more preferably not more than 35 W/kg. The lower limit of the eddy current loss Wₑ can be at least 0.1 W/kg. Here, these losses are measured at a maximum flux density (Bmax) of 1 T and a frequency of 400 Hz as described in EXAMPLES. The present embodiments can provide such numerical ranges to the molded product that has undergone a heating procedure. The heating temperature in the heating procedure can be 600° C., for example. The molded product with iron loss W and other losses within these numerical ranges may contain no resin and no glass. When the coated soft magnetic material, not the molded product, has undergone the heating procedure, the iron loss W, hysteresis loss Wₕ, and eddy current loss Wₑ of the coated soft magnetic material measured may be in the ranges described above.

### Molded Product

A molded product according to the present embodiments includes the above-described coated soft magnetic material. The molded product can be obtained by the method of producing a molded product described above. The molded product can be used as a powder magnetic core with lower iron loss in various applications. The molded product can be applied, for example, to transformers, coils, heads, inductors, reactors, cores (magnetic cores), yokes, various actuators, etc. The molded product can be used as a soft magnetic component to be incorporated into any of various motors, such as motors for rotating machines and linear motors. Examples of the motors for rotating machines include voice coil motors, induction motors, and reluctance motors.

### EXAMPLES

Examples are described below. It should be noted that “%” is by mass unless otherwise specified.

### (1) Evaluation Method

### (1-1) Iron Loss

The soft magnetic material was disposed into a mold having an inner diameter of 10 mm and an outer diameter of 14 mm. In the examples except for Example 16, the soft magnetic material was molded at an increased pressure of 1 GPa and then heat-treated in an Ar atmosphere at 600° C. for one hour to provide a toroidal molded product. In Example 16, 0.2% by mass of lubricants (1,2-bis(stearoylamino) ethane, zinc stearate) was added to the soft magnetic material, and the mixture was disposed into the same mold and molded at 200° C. under an increased pressure of 1.5 GPa, followed by heat treatment at 520° C. in the atmosphere and then at 600° C. in an Ar atmosphere for one hour to provide a toroidal molded product. These molded products were wound with a copper wire by 50 turns on the primary side and 50 turns on the secondary side to provide evaluation samples. These evaluation samples were evaluated for W10/400 (iron loss at 400 Hz and 1 T) using a B-H analyzer (SY-8218, available from Iwatsu Electric Co., Ltd.). At the same time, the iron loss was measured from 10 Hz to 1 kHz at a flux density of 1 T and fit to a second-order polynomial to determine the hysteresis loss Wₕ 10/400 and eddy current loss Wₑ 10/400 at 400 Hz and 1 T.

### (1-2) COATING THICKNESS AND ATOMIC CONCENTRATIONS

The coating thickness and atomic concentrations of the coated soft magnetic material were measured as follows. First, the provided coated soft magnetic material was molded into a φ10-mm disk and heated at 600° C. for one hour to provide a molded product. The molded product was embedded in EpoxiCure resin and then processed by ion milling, from which a sample was taken out by a microsampling method and then sectioned by focused ion beam (FIB). The respective values of the resulting sample were estimated using a scanning transmission electron microscope (STEM; available from JEOL; acceleration voltage 200 kV) and an energy dispersive X-ray analyzer (EDX; available from JEOL). To determine the atomic concentrations in the coating, a line scan was performed in steps of 0.791 nm or 0.957 nm from the exterior to the interior of the coated soft magnetic material to observe continuous changes in the atomic concentrations of the constituent elements, thereby determining a region where the atomic concentration of phosphorus (P) was at least 1 atom %. Here, because a lot of carbon (C) from the resin used to provide the cross-sectional sample might be detected in some measurement points, the atomic concentrations were calculated based on the total elements, excluding C.

### (2-1) Production of Coated Soft Magnetic Material

(i-i) Provision of Soft Magnetic Material: Examples 1 to 15, Comparative Examples 1 to 6

Fe—X alloys were provided as soft magnetic materials in Examples 1 to 15 and Comparative Examples 1 to 6. The Fe—X alloys were produced as follows. First, an aqueous solution was provided from MnCl₂·4H₂O (manganese (II) chloride tetrahydrate), NiCl₂·6H₂O (nickel (II) chloride hexahydrate), and FeCl₂·4H₂O (iron(II) chloride tetrahydrate) as raw materials. The aqueous solution and potassium hydroxide as a pH adjuster were used to provide a Mn—Ni-ferrite. The ferrite was heated at 12° C./min to 950° C. and then at 2° C./min to 1050° C., followed by reduction treatment at 1050° C. for one hour in a hydrogen atmosphere. The resulting product was then quenched to room temperature and then slowly oxidized in an argon atmosphere at an oxygen partial pressure of 3% by volume for 30 minutes to provide a soft magnetic material. The D50 of the Fe—Ni—Mn powder was 250 μm. The composition of the Fe—X alloy in Examples 7 to 10 and 15 and Comparative Examples 1 to 6 was Fe₉₆Ni_{3.9}Mn_{0.1}, and the composition of the Fe—X alloy in Examples 1 to 6 and 11 to 14 was Fe_{95.5}Ni_{4.4}Mn_{0.1}.

(i-ii) Provision of Soft Magnetic Material: Example 16

A soft magnetic material was produced by the same procedure as in Example 1, except that the raw materials used were MnSO₄·5H₂O (manganese (II) sulfate pentahydrate), NiSO₄·6H₂O (nickel (II) sulfate hexahydrate), and FeSO₄·7H₂O (iron(II) sulfate heptahydrate), and the pH adjuster used was NaOH.

(i-iii) Provision of Soft Magnetic Material: Examples 17 and 18, Comparative Example 7

A commercially available water-atomized iron powder was provided as a soft magnetic material in Examples 17 and 18.

### (ii) Washing of Soft Magnetic Material

The soft magnetic material listed in Table 2 in an amount of 10 g was added to an aqueous solution adjusted to pH 1.1 or lower with dilute hydrochloric acid, followed by stirring for ten minutes to remove the oxidized surface film and contaminants.

(iii-i) Coating Procedure: Examples 1 to 7, 16, and 17, Comparative Examples 3 to 6

To the washed soft magnetic material was added an aqueous solution containing 10% by mass of the additive element chloride and 10% by mass of the metal oxoacid compound listed in Table 2, each relative to the amount of the soft magnetic material, and the mixture was stirred for 15 minutes. Subsequently, an aqueous phosphate solution at pH 2 containing 40% by mass of the phosphate compound listed in Table 2 relative to the amount of the soft magnetic material was added, followed by stirring for seven minutes. The final concentration of each component was as follows: 1.6% by mass of the soft magnetic material, 0.16% by mass of each of the additive element chloride and the metal oxoacid compound, and 0.4% by mass of the phosphate compound (calculated as PO₄). The pH of the treatment tank rose from 3 to 5. Subsequently, an aqueous solution containing 10% by mass of the metal oxoacid compound listed in Table 2 relative to the amount of the soft magnetic material was added, and the reaction mixture was stirred for 30 minutes while the pH of the reaction mixture was controlled within the range of 2.5±0.1 by introducing 6% by mass of hydrochloric acid as needed.

(iii-ii) Coating Procedure: Examples 8 to 15 and 18, Comparative Example 2

To the washed soft magnetic material was added an aqueous solution containing 10% by mass of the metal oxoacid compound listed in Table 2 relative to the amount of the soft magnetic material, and the mixture was stirred for 15 minutes. Next, an aqueous phosphate solution at pH 2 containing 40% by mass of the phosphate compound listed in Table 2 relative to the amount of the soft magnetic material was added, followed by stirring for seven minutes. The final concentration of each component was as follows: 1.6% by mass of the soft magnetic material, 0.16% by mass of the metal oxoacid compound, and 0.4% by mass of the phosphate compound (calculated as PO₄). The pH of the treatment tank rose from 3 to 5.

(iii-iii) No Coating Procedure: Comparative Examples 1 and 7

In Comparative Examples 1 and 7, no coating procedure was performed.

(iv-i) Drying and Baking: Examples 1 to 18, Comparative Examples 2 to 6

The soft magnetic material after the coating procedure was dried by heating at 100° C. for four hours under vacuum conditions. The coating was then baked by heating at 200° C. for four hours.

(iv-ii) No Drying and No Baking: Comparative Examples 1 and 7

In Comparative Examples 1 and 7, no drying and no baking were performed.

### (2-2) Production of Molded Product

The coated soft magnetic materials thus provided were used to produce molded products for iron loss evaluation as described above for the evaluation method for iron loss. Moreover, the coated soft magnetic materials of Examples 7, 15, and 16 were used to produce molded products for coating evaluation as described above for the evaluation methods for coating thickness and atomic concentrations.

The iron loss (hysteresis loss and eddy current loss) was measured on the molded products for iron loss evaluation by the method above. Table 2 shows the results.

TABLE 2

| | Soft | | | | Losses @ 1 T, | | |
|---|---|---|---|---|---|---|---|
| | magnetic | Metal oxoacid | Phosphate | Additive element | 400 Hz | | |
| Ex.: | material | compound | compound | (chloride) | W | Wh | We |
| Ex. 1 | Fe—X | Sodium tungstate (Na₂WO₄) | Orthophosphoric acid, | Samarium chloride | 42.8 | 35.0 | 7.7 |
| | | | sodium dihydrogen phosphate | (SmCl₃) | | | |
| Ex. 2 | Fe—X | Sodium chromate (Na₂CrO₄) | Orthophosphoric acid, | Samarium chloride | 34.0 | 29.0 | 5.0 |
| | | | sodium dihydrogen phosphate | (SmCl₃) | | | |
| Ex. 3 | Fe—X | Potassium dichromate (K₂Cr₂O₇) | Orthophosphoric acid, | Samarium chloride | 36.2 | 29.5 | 6.7 |
| | | | sodium dihydrogen phosphate | (SmCl₃) | | | |
| Ex. 4 | Fe—X | Sodium metavanadate (NaVO₃) | Orthophosphoric acid, | Samarium chloride | 30.4 | 27.5 | 2.9 |
| | | | sodium dihydrogen phosphate | (SmCl₃) | | | |
| Ex. 5 | Fe—X | Sodium niobate (NaNbO₃) | Orthophosphoric acid, | Samarium chloride | 45.2 | 31.8 | 13.4 |
| | | | sodium dihydrogen phosphate | (SmCl₃) | | | |
| Ex. 6 | Fe—X | Potassium permanganate (KMnO₄) | Orthophosphoric acid, | Samarium chloride | 41.3 | 30.8 | 10.5 |
| | | | sodium dihydrogen phosphate | (SmCl₃) | | | |
| Ex. 7 | Fe—X | Sodium molybdate (Na₂MoO₄•2H₂O) | Orthophosphoric acid, | Samarium chloride | 47.9 | 41.7 | 6.1 |
| | | | sodium dihydrogen phosphate | (SmCl₃) | | | |
| Ex. 8 | Fe—X | Sodium niobate (NaNbO₃) | Orthophosphoric acid, | | 78.6 | 47.9 | 30.7 |
| | | | sodium dihydrogen phosphate | | | | |
| Ex. 9 | Fe—X | Phosphotungstic acid hydrate | Orthophosphoric acid, | | 95.5 | 47.9 | 47.6 |
| | | (P₂O₅•24WO₃•xH₂O) | sodium dihydrogen phosphate | | | | |
| Ex. 10 | Fe—X | Sodium tungstate (Na₂WO₄) | Orthophosphoric acid, | | 61.3 | 45.1 | 16.2 |
| | | | sodium dihydrogen phosphate | | | | |
| Ex. 11 | Fe—X | Sodium chromate (Na₂CrO₄) | Orthophosphoric acid, | | 60.1 | 45.9 | 14.1 |
| | | | sodium dihydrogen phosphate | | | | |
| Ex. 12 | Fe—X | Potassium dichromate (K₂Cr₂O₇) | Orthophosphoric acid, | | 36.6 | 32.7 | 3.9 |
| | | | sodium dihydrogen phosphate | | | | |
| Ex. 13 | Fe—X | Sodium metavanadate (NaVO₃) | Orthophosphoric acid, | | 40.5 | 34.0 | 6.5 |
| | | | sodium dihydrogen phosphate | | | | |
| Ex. 14 | Fe—X | Potassium permanganate (KMnO₄) | Orthophosphoric acid, | | 38.4 | 34.3 | 4.1 |
| | | | sodium dihydrogen phosphate | | | | |
| Ex. 15 | Fe—X | Sodium molybdate (Na₂MoO₄•2H₂O) | Orthophosphoric acid, | | 51.8 | 43.2 | 8.6 |
| | | | sodium dihydrogen phosphate | | | | |
| Ex. 16 | Fe—X | Sodium molybdate (Na₂MoO₄•2H₂O) | Orthophosphoric acid, | Samarium chloride | 38.6 | 32.4 | 6.2 |
| | | | sodium dihydrogen phosphate | (SmCl₃) | | | |
| Ex. 17 | Commercial | Sodium molybdate (Na₂MoO₄•2H₂O) | Orthophosphoric acid, | Samarium chloride | 91.4 | 52.6 | 38.8 |
| | iron powder | | sodium dihydrogen phosphate | (SmCl₃) | | | |
| Ex. 18 | Commercial | Sodium tungstate (Na₂WO₄) | Orthophosphoric acid, | | 204.6 | 77.7 | 126.9 |
| | iron powder | | sodium dihydrogen phosphate | | | | |
| Comp. | Fe—X | — | — | | 105.0 | 54.5 | 50.5 |
| Ex. 1 | | | | | | | |
| Comp. | Fe—X | — | Orthophosphoric acid, | | 82.8 | 48.0 | 34.7 |
| Ex. 2 | | | sodium dihydrogen phosphate | | | | |
| Comp. | Fe—X | — | Orthophosphoric acid, | Chromium chloride | 80.0 | 48.0 | 31.9 |
| Ex. 3 | | | sodium dihydrogen phosphate | (CrCl₃) | | | |
| Comp. | Fe—X | — | Orthophosphoric acid, | Vanadium chloride | 73.8 | 43.2 | 30.6 |
| Ex. 4 | | | sodium dihydrogen phosphate | (VCl₃) | | | |
| Comp. | Fe—X | — | Orthophosphoric acid, | Manganese chloride | 86.0 | 56.5 | 29.4 |
| Ex. 5 | | | sodium dihydrogen phosphate | (MnCl₂) | | | |
| Comp. | Fe—X | — | Orthophosphoric acid, | Molybdenum chloride | 52.0 | 41.4 | 10.7 |
| Ex. 6 | | | sodium dihydrogen phosphate | (MoCl₅) | | | |
| Comp. | Commercial | — | — | — | 328.7 | 185.6 | 143.1 |
| Ex. 7 | iron powder | | | | | | |

### Example

### Comp. Ex.: Comparative Example

Comparative Example 1 (no coating procedure) and Comparative Example 2 (no metal oxoacid compound) showed high iron losses. Compared to Comparative Example 3 in which chromium chloride was used, Examples 2, 3, 11, and 12 in which a chromium oxoacid compound was used showed reduced iron losses. Compared to Comparative Example 4 in which vanadium chloride was used, Examples 4 and 13 in which a vanadium oxoacid compound was used showed reduced iron losses. Compared to Comparative Example 5 in which manganese chloride was used, Examples 6 and 14 in which a manganese oxoacid compound was used showed reduced iron losses. Compared to Comparative Example 6 in which molybdenum chloride was used, Examples 7 and 15 in which the same soft magnetic material was used and a molybdenum oxoacid compound was used as a metal oxoacid compound showed reduced iron losses. Examples 1 to 7 in which samarium chloride was used together showed significantly reduced iron losses.

Compared to Example 17 in which the coating procedure was performed on the commercially available iron powder, Example 7 in which the same coating procedure was performed on the Fe—X alloy showed reduced iron loss, hysteresis loss, and eddy current loss. Also, compared to Example 18 in which the coating procedure was performed on the commercially available iron powder, Example 1 in which the same coating procedure was performed on the Fe—X alloy showed reduced iron loss, hysteresis loss, and eddy current loss. These results demonstrate that the coating procedure had a larger effect when performed on the Fe—X alloys.

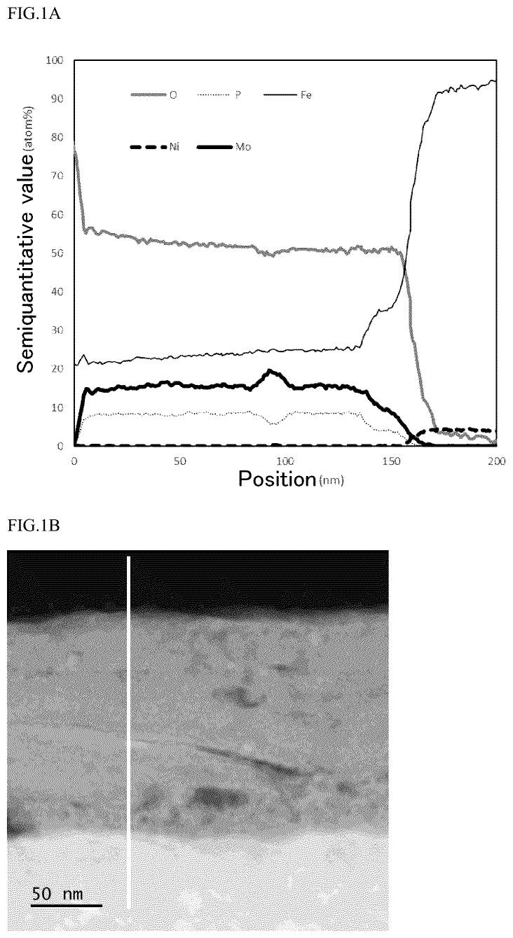

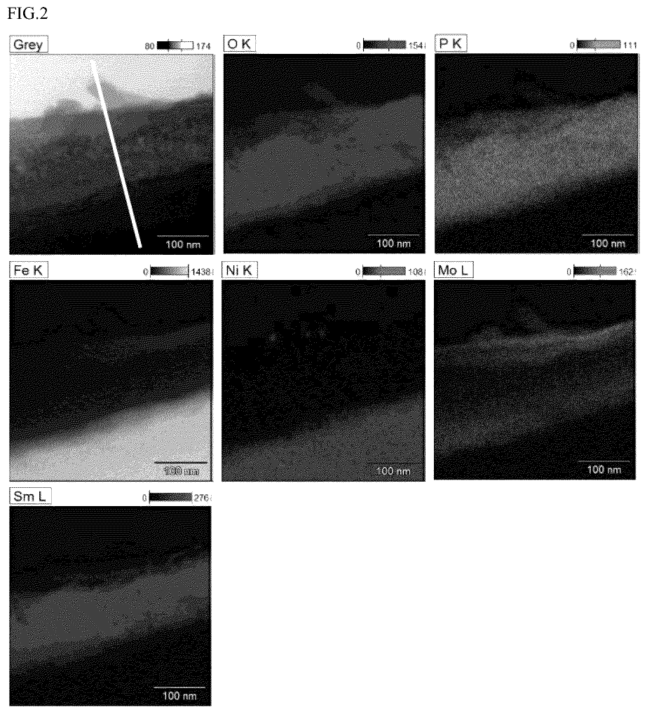

A portion near the surface of the molded product for coating evaluation with the coated soft magnetic material of Example 15 was observed using STEM-EDX. FIG. 1B shows the obtained STEM image. The line scan results shown in FIG. 1A were based on measurements along the white line in FIG. 1B. The results demonstrate that an M compositional gradient phase, where the amount of Mo as an M component decreases from that in the passive film composition, is present between the 100 nm and 180 nm positions in the direction from the surface of the coating toward the base material magnetic material. This gradual M compositional gradient phase extending over 80 nm probably allows the coating to maintain its bond to the base material (soft magnetic material) without peeling from it even under heat stress or mechanical stress, probably resulting in high heat resistance.

If a component contained in the soft magnetic material but not in the coating, such as Ni in Example 15, is present, the position where the M compositional gradient phase begins can be easily recognized. In FIG. 1A, the M compositional gradient phase begins at the position (168 nm) where the compositional percentage of Ni is 0. A portion near the surface of the molded product for coating evaluation with

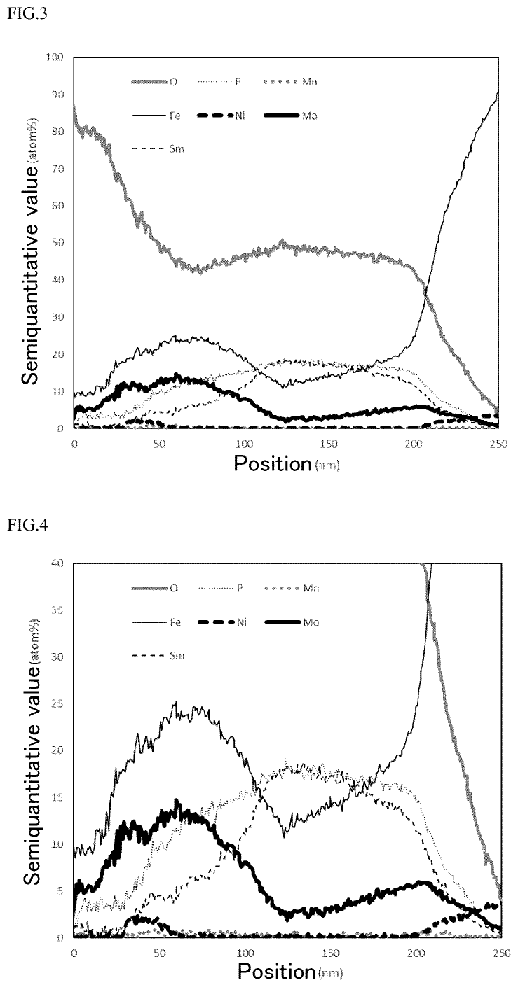

the coated soft magnetic material of Example 7 was observed using STEM-EDX. The obtained STEM image is shown in FIG. 2. FIG. 2 includes elemental mapping (EDS) images of O, P, Fe, Ni, Mo, and Sm. The line scan results of metallic elements, P, and O on the white line in the image labelled as “Grey” in FIG. 2 are shown in FIGS. 3 and 4. FIG. 4 is an enlarged view of the region from 0 to 40 atom % in FIG. 3.

In FIGS. 2 to 4, the thickness of the coating on the surface of the magnetic material was about 200 nm. In FIG. 4, O was present in a larger amount than P throughout the coating. In the direction from the surface of the coating toward the magnetic material, the maximum amounts of Mo and Fe were observed, and then the maximum amount of Sm was observed. Here, Mo is probably derived from the sodium molybdate added in the coating procedure, and Fe is probably derived from the soft magnetic material (base material).

If the aqueous solution during the coating reaction contains a rare earth metal element, Ni can be contained in the coating in some cases. In such cases, the method focused on the Ni content is not suitable for identifying an M compositional gradient phase; instead, the M compositional gradient phase can be determined from changes in the amount of Mo as an M component. The line scan results in FIGS. 3 and 4 demonstrate that an M compositional gradient phase where the amount of Mo as an M component decreases from that in the passive film composition is formed between the 100 nm and 180 nm positions. In Example 7, an M component and a rare earth metal element that has a low AG and gives a thermodynamically stable oxide or phosphate compound are present in the layer inside the passive film phase with high Fe and M component contents. This allows the resulting coated soft magnetic material to have good heat resistance and good oxidation resistance. The Fe—X alloy in Example 7 was produced by reducing a ferrite powder, which mainly contained an X component that was not easily reduced by hydrogen, in a reducing gas containing hydrogen gas, followed by a disproportionation reaction to form a first phase and a second phase. The thus-obtained structure has a large surface area with fine compositional fluctuations. Due to this structure, the alloy is presumed to easily form a passive film with a metal oxoacid, in particular, an M oxyacid.

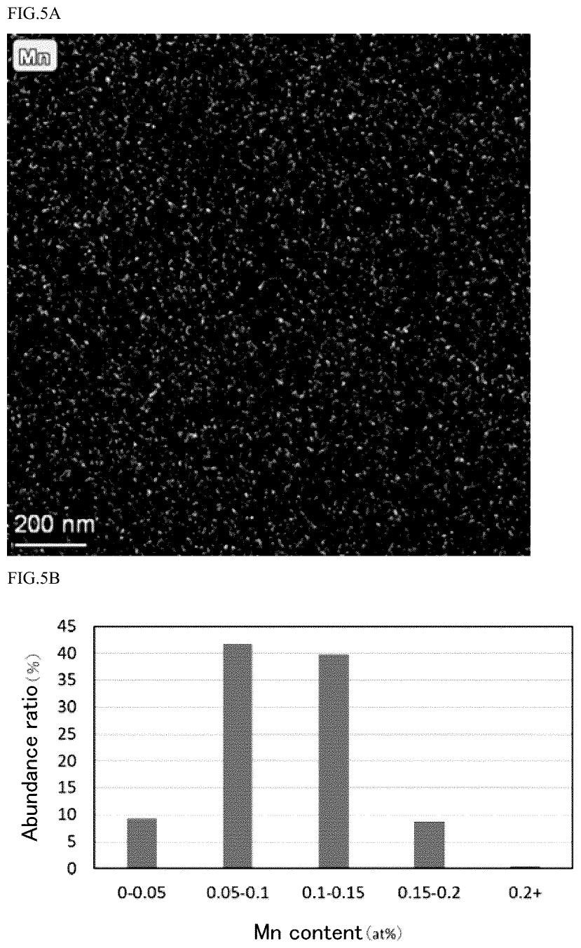

A portion of a cross-section of the molded product for coating evaluation with the coated soft magnetic material of Example 16 was observed using STEM-EDX. FIGS. 5A and 5B show the results. FIG. 5A is a Mn distribution chart measured by STEM-EDX analysis using characteristic X-rays. The black colored areas indicate low Mn contents and the white colored areas indicate high Mn contents. In this EDX analysis, the screen was divided into 512×512 pixels of 3 nm square, and the characteristic X-ray dose at the center of each pixel was measured by focusing the electron beam diameter to 1 nm. FIG. 5B is a histogram showing the distribution of Mn content. In FIG. 5B, the distribution of Mn content is displayed by dividing the Mn contents at all measurement points into the following five classes: at least 0 atom % but less than 0.05 atom % (indicated as 0-0.05 on the horizontal axis in the histogram); at least 0.05 atom % but less than 0.1 atom % (indicated as 0.05-0.1 on the horizontal axis in the histogram); at least 0.1 atom % but less than 0.15 atom % (indicated as 0.1-0.15 on the horizontal axis in the histogram); at least 0.15 atom % but less than 0.2 atom % (indicated as 0.15-0.2 on the horizontal axis in the histogram); and at least 0.2 atom % (indicated as 0.2+ on the horizontal axis in the histogram), and expressing the number of pixels of each compositional class as a percentage (referred to as abundance ratio). FIG. 5B shows that the abundance ratio of pixels having a compositional percentage of Mn of at least 0 atom % but less than 0.05 atom %, corresponding to a first phase, is about 10% of the total pixels. The abundance ratio of pixels having a Mn content of at least 0.1 atom % is about 50% of the total pixels and is thus considered to be the abundance ratio of a second phase having a Mn content higher than the Mn content of the first phase. FIGS. 5A and 5B demonstrate that the Fe—X alloy as a soft magnetic material used in the coated soft magnetic material of Example 16 was phase-separated into the first phase and the second phase.

What is claimed is:

1. A method of producing a coated soft magnetic material, comprising
a coating procedure comprising mixing an aqueous solution containing a phosphate compound and a metal oxoacid compound with a soft magnetic material to form a coating containing a metal phosphorus compound on a surface of the soft magnetic material.

2. The method of producing a coated soft magnetic material according to claim 1,
wherein the metal oxoacid compound is an oxoacid compound of Cr, W, Mn, Mo, Nb, or V.

3. The method of producing a coated soft magnetic material according to claim 1,
wherein an inorganic acid is added to the aqueous solution to adjust a pH of the aqueous solution to at least 1 but not higher than 4.5.

4. The method of producing a coated soft magnetic material according to claim 3,
wherein the pH of the aqueous solution is adjusted for at least 10 minutes.

5. The method of producing a coated soft magnetic material according to claim 1,
wherein in the coating procedure, an aqueous solution containing the metal oxoacid compound is mixed with the soft magnetic material and then with the phosphate compound.

6. The method of producing a coated soft magnetic material according to claim 1,
wherein the coating procedure is performed at least twice.

7. The method of producing a coated soft magnetic material according to claim 6,
wherein the coating procedure is performed at least k times, where k is an integer of at least 2, and
wherein the aqueous solution used in the k-th coating procedure is obtained by adding the metal oxoacid compound to the aqueous solution used in the (k−1)th coating procedure.

8. The method of producing a coated soft magnetic material according to claim 6,
wherein the coating procedure is performed at least m times, where m is an integer of at least 2, and
wherein the metal oxoacid compound used in the m-th coating procedure is different from the metal oxoacid compound used in the (m−1)th coating procedure.

9. A method of producing a molded product, comprising:
obtaining a coated soft magnetic material by the method according to claim 1; and
heating the coated soft magnetic material.

10. A coated soft magnetic material, comprising:
a soft magnetic material; and
a coating provided on a surface of the soft magnetic material,
wherein the coating comprises an M component main phase mainly containing an M component, and an M compositional gradient phase positioned between the M component main phase and the soft magnetic material and has an M component content decreasing in a direction toward the soft magnetic material,
the M compositional gradient phase has a thickness of at least 20 nm in a direction from the M component main phase toward the soft magnetic material, and
the M component is at least one of Cr, W, Mn, Mo, Nb, or V.
